(19) United States
(12) Patent Application Publication
(10) Pub. No.: US 2006/0090326 A1
(43) Pub. Date: May 4, 2006

(54) Modular cementitious thermal panels with electric elements

(76) Inventor: A. Hoyt Corbett, Bainbridge Island, WA (US)

Correspondence Address: Jeffrey T. Haley;GRAYBEAL JACKSON HALEY LLP, Suite 350, 155 - 108th Avenue NE, Bellevue, WA, 98004-5901, US

(21) Appl. No.: 11/303,787

(22) Filed: Dec. 16, 2005

Related U.S. Application Data
(63) Continuation-in-part of application No. 10/172,284, filed on Jun. 14, 2002, now Pat. No. 6,805,298.
(63) Continuation-in-part of application No. 10/770,805, filed on Feb. 3, 2004, now abandoned.

(51) Int. Cl. B21B 1/46; H05B 3/00

(52) U.S. Cl. 29/527.1; 29/611

(57) ABSTRACT

An electric thermal heating panel made of cementitious material. The panel is made of Portland cement or any other cement that cures to a stiff hardness. The cement may include sand and reinforcing fibers, such as glass, polymer, or wood fibers. Like other heating panels, one or more groves are deep enough to entirely receive an electric heating element. The panel has backing material to provide strength or sufficient thickness of cementitious material beneath each groove to give adequate strength. The panel may be adhered with mortar or other adhesive or with nails or screws. The panels may be covered with mortar and tile or with any other flooring material.

This invention relates to building construction materials and is particularly directed to improved thermal heating panels for application of electric floor heating in new and existing construction. It is a continuation in part of application Ser. No. 10/770,805 filed Feb. 3, 2004, now abandoned, which was a divisional of application Ser. No. 10/172,284, issued as U.S. Pat. No. 6,805,298, which claims priority from provisional application No. ______ filed Jun. 14, 2001.

### SUMMARY OF THE INVENTION

In one aspect, the invention is a thin, relatively dense, non structural, modular cementitious thermal mass, made into panels (or boards) for use in floor heating. This embodiment consists of panels made of cementitious materials with a groove or grooves for placing wires, that have been extruded, molded, or pressed into the panels while the cement is soft. The grooves for placing the wires may be undercut to retain the wires, tightly fitting to retain the wires by friction, or loose on the wires. The panels may be attached to a subfloor by means of adhesive, mortar, screws or other normal construction attachments. The panel shapes may be cast, pressed or extruded out of cementitious materials and either may or may not include the addition of reinforcing mesh, natural fibers, glass or ceramic fibers, polymers, metal filings or fibers, or filler. They may also or may not include additional layers of backing materials, metal for better heat transfer, soundproofing, insulation, reinforcement, and edge strips.

By cementitious materials I mean relating to cement in the sense that it is made of any substance that is mixed in a flowable (whether liquid or powder) consistency that later hardens, whether with or without application of heat or pressure. Cementitious boards made with Portland cement are commonly used for such purposes. Other cements are suitable but, today, are not as low cost. With technological improvements or changes in economics, these cements may become as practical as Portland cement. Examples are epoxies, polyesters, thermoplastics, ceramics, and all manner of filer material held together with modern adhesives such as cyanurate adhesives, urethane adhesives, and urea-formaldehyde adhesives.

By being made of a cementitious material that is stiff enough, the product can be installed normally using standard materials and practices of the tile trades such as thin set mortar. In one embodiment, tile can be attached directly on top of it with thin set mortar or other normal tile setting materials. This has the advantage that the product can easily be installed over wood, cement or other normal sub floor materials using any glue or adhesive or attachment method known in the construction trades.

In one aspect, the invention allows easy to use methods of floor heating that can be easily integrated into standard construction practice at a cost that is moderate. The boards can be used under sheet goods such as vinyl sheets as well as any other kind of floor covering, including a layer of epoxy.

In another aspect, the invention provides the advantages of cement for floor heating in a modular easy to use form without the need for pouring cement at the job site.

In another aspect, the invention provides a product that is friendly to and works well with many of the materials of the tile industry for use in installation.

### BRIEF DESCRIPTION OF THE DRAWINGS

FIG. 1a shows a basic panel.

FIG. 1b shows a panel with an additional metal layer 4 on the top.

FIG. 1c shows a panel with an additional metal layer in the board and an additional layer of cementitious material under the metal layer.

FIG. 2a shows a panel with a backing layer 6.

FIG. 2b shows a panel with a metallic layer 4 and a backing layer 6.

FIG. 3a shows a panel with the addition of non-brittle strips 7 on the edges.

FIG. 3b shows a panel 2 with non-brittle strips 7 on the edges and a metal layer 4 under the board.

FIG. 3c shows a panel 2 with non-brittle strips and a backing layer 6.

FIG. 4a shows an embodiment of the invention like FIG. 1a with a layer 8 of flooring materials applied to the top

### DETAILED DESCRIPTION

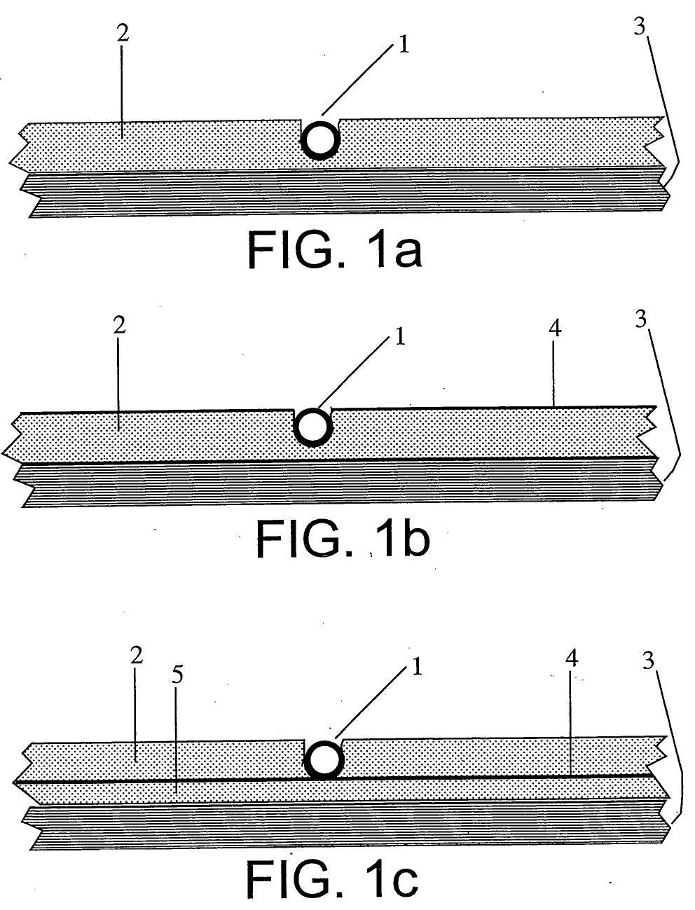

FIG. 1a is a sectional view of a panel 2 made of cementitious materials which can retain an electric or hydronic heating element 1 in a groove formed by cutting (routing) or by molding. The panel board is normally installed by means of any combination of nailing, screwing, or adhering to a floor or sub floor 3.

For forming the panels, Portland cement is suitable, as well as any other cement that can substitute for Portland cement, such as epoxies, polyesters, Durham's Rock-Hard putty, Dowman's Fixall, and all manner of filer material held together with modern adhesives such as cyanurate adhesives, urethane adhesives, and urea-formaldehyde adhesives. The standard mixtures with sand and reinforcing fibers used for standard 4 feet by 8 feet cement boards are suitable. The sand provides good hardness for a tile base, good thermal mass, and good thermal conductivity. Alternative mixtures include plant fibers in the form of cellulose particles, filings, fibers, chips or strands of wood or other plants, glass, polymer, or ceramic fibers to increase strength and flexibility for nailing. Metal filings or fibers, such as tin, aluminum, zinc or similar alloy filings, can be added to adjust thermal mass or thermal conductivity. The additives can be adjusted to give the product desirable construction characteristics such as sawability, nailability and compatibility with construction attachment and bonding methods.

A suitable method for forming the grooves is to attach an appropriate linear shape, such as a tube plus crack filler material such as silicone sealer, or a cross-hatch grid shape with a multiplicity of possible paths, to one side of a mold for making the panels. The grooves may be given a desirable undercut shape by making the shapes of a soft, rubbery material, such as a soft rubber tube, that will deform as it is pulled out of the hardened panel, just like a plastic tube will deform when it is pushed into the groove to then snap into place, and filling the crack between the mold surface and the round pipe less than all the way out to a diameter of the pipe parallel to the mold surface. A linear shape of the preferred cross section may be molded or extruded and then attached to the mold surface. Fibrous backing material may be placed in the other half of the mold before the cementitious material is introduced.

Instead of grooves with a constant cross-section and an undercut, the grooves may be made with tabs extending over a part of the groove from one side and then from the other side. The wires are placed into such grooves by deflecting the wire to one side and then the other as the wire moves through the installer's hands, catching under a tab on one side, then a tab on the other side, etcetera. Such a groove with alternating tabs may be made with an elastic rubber mold insert as described above, and the insert may be molded from a thermosetting rubber. Alternatively, the insert with alternating protruding tabs (or with a constant undercut) may be made with a rigid but multi-part mold insert where some insert parts are removed before others to allow parts under the tabs to be removed at an angle or in a two step movement.

Another suitable method for forming the panel with straight grooves is to extrude cementitious material through a die with one or more protrusions on one side of the die to form one or more straight grooves, then cutting the extrusion to preferred lengths.

Each panel is preferably made no thicker than necessary to accommodate the heating element and have adequate strength. Heating element wires with insulation can be obtained with a diameter smaller than 3/16 inch. For these wires, the panels can be as thin as ⅜ to ½ inch thick. Where building codes require that the wires be a minimum depth below the surface of the top level of the panels, the panels can be made thicker and the grooves deep enough to hold the wires at a suitable depth.

For installation, in one embodiment of the panel that is supplied as part of a kit with wires, many heating element wires of standard pre-cut length are supplied to ensure that each element will have the same resistance. The wires are connected in parallel to give them all the same voltage. A preferred form of panel has a grid of many possible paths that a wire can take through any panel, allowing the installer to snake a wire as necessary to take up its length. Low resistance copper wires that do not significantly heat up may be laid in the grooves and then connected to heating element wires to reach more distant spots in a particular installation.

Nichrome wires with high temperature insulation, such as teflon or nylon insulation, are suitable. Newer heating elements that are engineered to change electrical resistance as they heat up so that they reach an equilibrium temperature and do not get much hotter are preferred.

Once the wires have been laid, it is preferred to fill the cracks between the wires and the groove edges, as well as filling any unused grooves, with mortar or similar cementitious material which then hardens. The material need not have significant tensile strength, but it should have high heat conductivity to conduct heat out of the wires and into the panels. Thin set mortar and plasters with sand are suitable. Thermal conductivity may be increased by adding metal filings, particles, or filaments.

Panels may be made with straight grooves. Other panels, for adjoining the straight groove panels, have a grid of grooves or have 180 degree curved grooves so that a pipe can make a full turn and return to the straight groove panel or have 90 degree curved grooves. Panels can be cut with a saw at the time of installation. Suitable dimensions for the straight groove panels are 16 inches wide by 48 inches long with two lengthwise grooves in each panel.

FIG. 1b is a sectional view of a panel 2 made out of cementitious materials which can retain the heating element 1 in the formed groove. The board is normally installed by means of any combination of nailing, screwing, or adhering to a floor or sub floor 3 and has an additional metal layer 4 on the top of the cementitious board, adhered by the cement itself or by an additional adhesive.

FIG. 1c is a sectional view of a panel 2 made out of cementitious materials which can retain the heating element in the formed groove. The board is normally installed by means of any combination of nailing, screwing, or adhering to a floor or sub floor 3 and has an additional metal layer 4, such as aluminum or tin or zinc or similar alloy foil, in the cementitious board and includes an additional layer 5 of cementitious material under the metal layer.

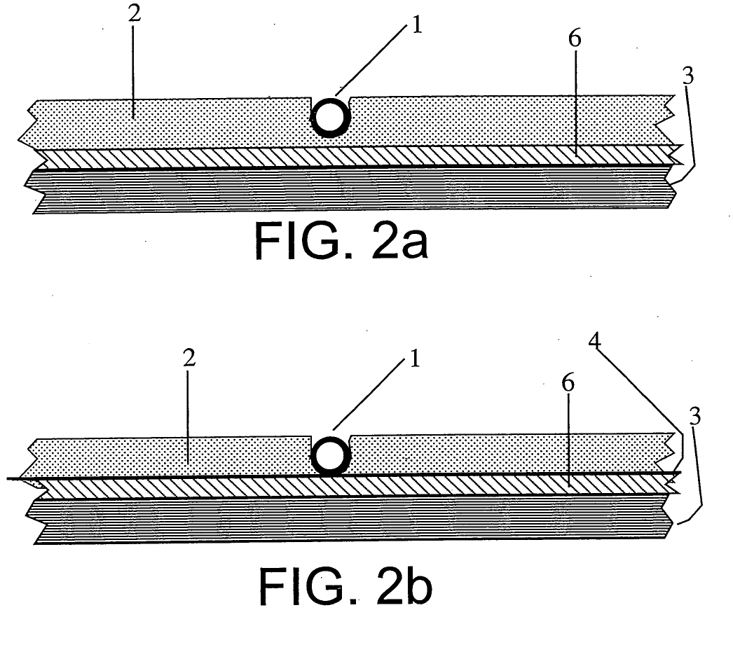

FIG. 2a is a sectional view of a panel 2 made out of cementitious materials which can retain the heating element 1 in the formed groove and has a backing layer 6 or layers fibrous backing material that may include wood fiber in any form such as wood, plywood, wood chips, wood fibers, wood particles, or may include reinforcing, soundproofing, or insulation materials such as an insulating board made of fiberglass and resin.

FIG. 2b is a sectional view of a panel 2 made out of cementitious materials which can retain the heating element 1 in the formed groove with the addition of an metallic layer 4 either between layers and may have a backing layer 6 or layers that may include wood, wood chips, wood fibers, wood particles, cementitious material, reinforcing, soundproofing, or insulation materials. As shown in FIG. 2b, because the backing layer provides strength, the groove for the heating element 1 may extend entirely through the cementitious material 2.

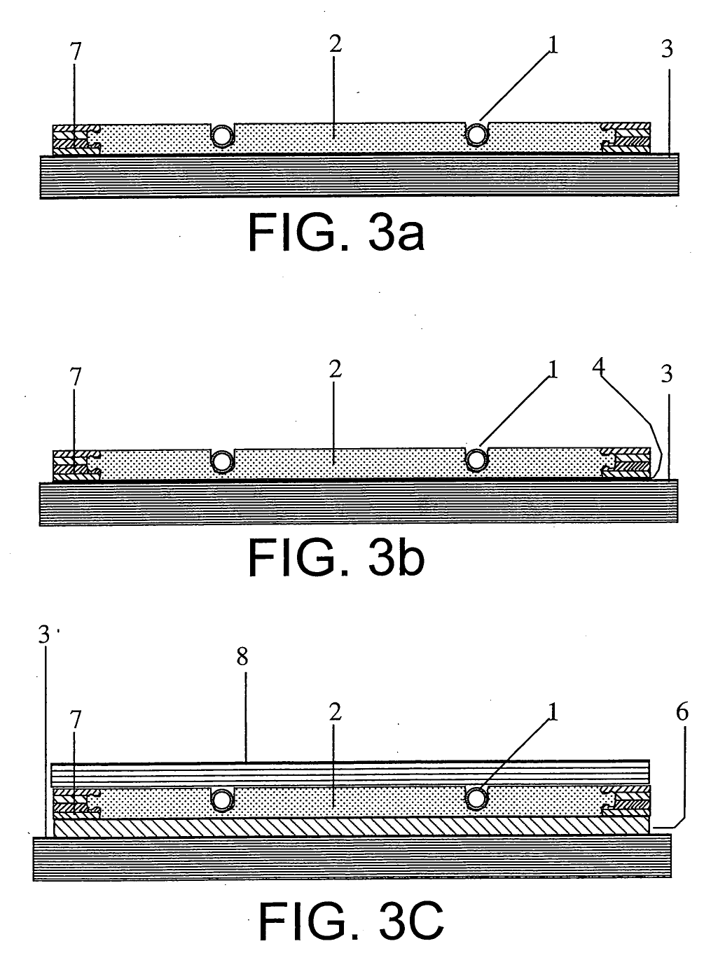

FIG. 3a is a sectional view of a panel 2 made out of cementitious materials which can retain the heating element in the formed groove with the addition of nailable wood in any form, such as plywood, OSB, or composite wood strips 7 on the edges as an aid for attachment to wooden floors and for the purpose of providing nailing areas for flooring materials that might be installed from above. The board is normally installed by means of any combination of nailing, screwing, or adhering to a floor or sub floor 3.

FIG. 3b is a sectional view of a panel 2 made out of cementitious materials which can retain the heating element 1 in the formed groove with the addition of wood, plywood or composite wood strips 7 on the edges as an aid for attachment to wooden floors and for the purpose of providing nailing areas for flooring materials that might be installed from above 8 with a metal layer 4 under the board.

FIG. 3c is a sectional view of a panel 2 made out of cementitious materials which can retain the heating element in the formed groove with the addition of wood, plywood or composite wood strips on the edges as an aid for attachment to wooden floors and for the purpose of providing nailing areas for flooring materials 8 that might be installed from above and has a backing layer 6 or layers that may include wood, wood chips, wood fibers, wood particles, cementitious material, reinforcing, soundproofing, and insulation materials.

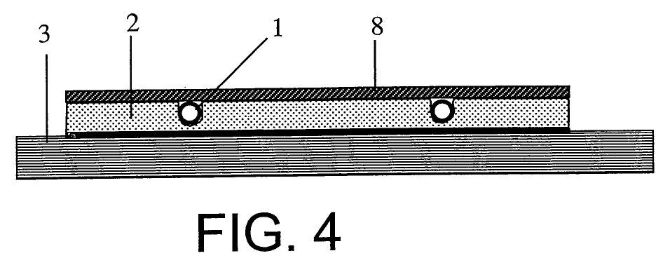

FIG. 4a shows an embodiment of the invention like FIG. 1a with a layer 8 or layers of flooring materials applied to the top by means of any combination of nailing, screwing, or adhering.

In addition to making modular panels with grooves for placing wires, modular panels may be made with wires embedded and with metal-to-metal connectors at edges of the panels. Each panel has line 1 and line 2 inputs, low resistance copper wires connecting these to one or two or three line 1 and line 2 outputs, and one or more heating element wires connecting from line 1 to line 2 within the panel. These modular panels can be connected to each other in many configurations without concern to ensure that heating element wires are all a proper length. The connected copper wires will have widely varying lengths, but this is of little concern because they have low resistance and adequate gauge to carry the current for a specified maximum number of downstream panels. Panels with grooves as described above can be used at complicated junction areas and installers can make the connections at these points by cutting copper wires to the needed lengths.

These modular panels with embedded heating wires are each made by a process like the prior art of pouring a custom concrete floor with embedded heating wires. The panels all have a uniform shape and size, such as two feet by four feet, so that they can be assembled into a large variety of shapes, and they may have interlocking configurations on their edges.

The panels with embedded wires can be made with tiles pre-adhered so only grouting is required after placing the panels. The panels can be made originally out of ceramic with embedded heating wires to save labor, weight, and thickness caused by adding tiles to the panel. To make them out of ceramic, grooves may be formed on the bottom sides of large ceramic tiles in the original formation process and then, after the glaze is fired onto the tiles, wires with edge connectors are adhered into the grooves on the bottom sides.

In one embodiment for the electric connectors at the edges, the line 1 and line 2 wires are coupled to pins within recessed sockets within the edge of the panel. The pins are sufficiently recessed that they will not touch each other when two panels are abutted and there is room between them for insulating covers. As shipped, each pin is covered with a plastic cover that can be easily removed with fingers. As the panels are being installed, the installer pulls the plastic cover off of two input pins (line 1 and line 2) and replaces them with metal connectors, each in the form of a cylinder with a full length slit that allows the cylinder to expand. The cylinder is made of springy (elastic) metal. Pushing the connector onto the pin slightly expands the slit cylinder, leaving it clamped onto the pin with its elastic restoring force. Other covers on the same panel can be removed to provide power out to adjoining panels using identical connectors.

So that the panels can be “hinged” into place without distorting the pins or the connectors, each pin has a spherical head so that the connector can pivot about 20 degrees in any direction. As two panels are connected, they can form an angle anywhere from 180 degrees to about 140 degrees without distorting the pins or connectors. A suitable size for the sphere is 3/16 inch diameter, at the end of a 1/16 inch diameter pin.

The well surrounding the pin is a cup made of electrically insulating material, such as injection molded plastic, with an outer dimension between a flat top surface and a flat bottom surface of the cup as thick as the panel. Three outer surfaces of the cup are molded with a jig saw puzzle type interlocking surface so they can be securely molded into the cement as it cures. One of these surfaces has the metal pin protruding into the panel where it is coupled to the copper wire (or directly to the heating element) with a clamped or welded metal connector. The sixth surface of the cup has the recess with the pin in the recess.

While various embodiments of the invention have been shown, many others are possible. The scope of the invention is not to be limited by the above descriptions but only by the following claims:

I claim:

1. A method for making a cementitious panel for electric heating, the method comprising:
(a) placing cementitious material in a mold having two sides, one side of the mold having an attached linear shape to form at least one groove in a surface of the panel;
(b) allowing the cementitious material to cure to form a panel; and
(c) extracting the linear shape from the cured material, leaving a groove in the panel sized to receive electric heating elements.

2. The method of claim 1 wherein the linear shape is undercut and forms an undercut groove.

3. The method of claim 1 wherein the cementitious material comprises Portland cement.

4. The method of claim 1 wherein the cementitious material comprises cement with reinforcing fibers.

5. The method of claim 4 wherein the reinforcing fibers comprise glass fibers.

6. The method of claim 4 wherein the reinforcing fibers comprise polymer fibers.

7. The method of claim 4 wherein the reinforcing fibers comprise plant fibers.

8. The method of claim 1 further comprising adding a layer of fibrous backing material.

9. A cementitious panel for electric heating made by the method of claim 1.

10. A cementitious panel for electric heating made by the method of claim 2.

11. A cementitious panel for electric heating made by the method of claim 3.

12. A cementitious panel for electric heating made by the method of claim 4.

13. A cementitious panel for electric heating made by the method of claim 5.

14. A cementitious panel for electric heating made by the method of claim 6.

15. A cementitious panel for electric heating made by the method of claim 7.

16. A cementitious panel for electric heating made by the method of claim 8.

17. A method for making a cementitious panel for electric heating, the method comprising:
(a) extruding cementitious material through a die having two sides, one side of the die having at least one protrusion to form at least one groove in a surface of the panel;
(b) allowing the cementitious material to cure; and
(c) cutting the extruded material to form a panel.

18. The method of claim 17 wherein the linear protrusion is undercut and forms an undercut groove.

19. The method of claim 17 wherein the cementitious material comprises Portland cement.

20. The method of claim 17 wherein the cementitious material comprises cement with reinforcing fibers.

21. The method of claim 20 wherein the reinforcing fibers comprise glass fibers.

22. The method of claim 20 wherein the reinforcing fibers comprise polymer fibers.

23. The method of claim 20 herein the reinforcing fibers comprise plant fibers.

24. A cementitious panel for electric heating made by the method of claim 17.

25. A cementitious panel for electric heating made by the method of claim 18.

26. A cementitious panel for electric heating made by the method of claim 19.

27. A cementitious panel for electric heating made by the method of claim 20.
